(19) United States
(12) Patent Application Publication
(10) Pub. No.: US 2004/0112688 A1
(43) Pub. Date: Jun. 17, 2004

(54) Brake wear compensator

(76) Inventor: Yvon Rancourt, Quebec (CA)

Correspondence Address: BIRCH STEWART KOLASCH & BIRCH, PO BOX 747, FALLS CHURCH, VA, 22040-0747, US

(21) Appl. No.: 10/468,650

(22) PCT Filed: Feb. 21, 2002
(86) PCT No.: PCT/CA02/00217

(51) Int. Cl. F16D 55/36

(52) U.S. Cl. 188/71.5

(57) ABSTRACT

A disc brake assembly (10) has a housing (12) mounted to a vehicle and two rotor discs mounted to a wheel of the vehicle. Three annular brake shoes (30,54,76) are operatively supported by the housing (12) and a support structure of the vehicle, respectively. Rotor discs and two of the annular brake shoes are adapted to move axially towards an axially restrained brake shoe for frictional engagement with one another during a brake action. The housing (12) includes an annular radial wall (14) and a plurality of axial link members (16) circumferentially spaced apart from one another. The link members (16) are secured to the support structure of the vehicle using mounting screws (102) received in mounting bores (100) thereof. Each mounting bore (100) extends radially through an elongated key (98) and is offset from the center of the key. The elongated key (98) is adapted to be inserted in opposite orientations in an elongated aperture defined in the distal end of the axial link member (16) of the housing (12) so that the axial position of the mounting bores (100) is selected. The simple structure of the housing (12) provides an adjustment feature to reduce the travel distance of moving parts to compensate for wear. This wear compensation solution is reliable and inexpensive.

### BACKGROUND OF THE INVENTION

1. Field of the Invention

The present invention relates to disc brakes and more particularly to improvements for wear compensation in large area contact disc brakes for vehicles.

2. Description of the Prior Art

The disc brake of the present invention is a disc brake of the type described in U.S. Pat. No. 5,330,034 issued Jul. 19, 1994 and United States patent RE 35055 issued Oct. 10, 1995 referring to full annular disc brakes for large vehicles such as trucks. The concept of the full annular disc brake is also proposed for automobiles and light trucks and the applicant describes a structure of a full annular disc brake for such vehicles in the applicant's PCT patent application PCT/CA97/01014, entitled IMPROVED DISC BRAKE ASSEMBLY and published as WO98/29671 in the inventor's name, Rancourt on Jul. 9, 1998. The disc brake assembly for a vehicle as described in the applicant's PCT application WO98/29671 generally includes a housing mounted to the vehicle, an annular rotor disc within the housing, and means for mounting the disc to the wheel.

The disc has at least a first radial planar annular friction surface and the housing includes a first annular brake shoe provided adjacent to the first friction surface of the disc. The brake shoe is axially moveable towards and away from the first friction surface and is restrained from rotating with the disc. An annular fluid expandable bladder extends between the first annular brake shoe and a radial wall of the housing, so that upon expansion of the bladder the first brake shoe moves axially to frictionally engage the first friction surface of the disc. There is a means provided for disengaging the first brake shoe from frictional contact with the first friction surface of the rotor disc. However, the travel distance of the brake shoe increases as a result of the wearing of the friction surface of the disc and the brake shoe. The longer distance the brake shoe travels, the more time is needed to react to a brake action and fully stop the vehicle. Therefore, the travel distance of the brake shoe must be adjusted to an acceptable range when the wearing exceeds the range.

Methods of compensation for wear of disc brakes are well known and, for example, are described in U.S. Pat. No. 5,660,250 issued to Treude on Aug. 26, 1997 and U.S. Pat. No. 5,433,299 issued to Sundstrom et al on Jul. 18, 1995. The applicant in his Canadian patent application 2,289,812 filed Nov. 15, 1999, describes a friction plate return mechanism which is adapted to be automatically adjusted to compensate for the increase in the travel distance of the brake shoe in brake actions.

Nevertheless, the industry is continuously making efforts to improve wear compensation mechanisms, to better serve different types of disc brakes, multiple disc brakes in particular, with more efficient, simpler and less expensive solutions.

### SUMMARY OF THE INVENTION

It is an object of the present invention to provide a simple structure of a wear compensation mechanism for use in disc brakes, particularly in a full annular disc brake for vehicles.

It is another object of the present invention to provide a disc brake housing, especially for a full annular disc brake for automobiles, that has an improved configuration to aid in adjustment of axial space for wear composition of the disc brake.

It is a further object of the present invention to provide a disc brake assembly that is provided with a simple structure for adjustment to compensate for wear.

It is a still further object of the present invention to provide a wear compensation multiple disc brake assembly which has more than one rotor disc and provides a simple structure for adjustment to compensate for wear.

A disc brake assembly for a vehicle wheel generally includes a housing, at least first and second annular brake shoes, and at least a rotor disc co-axially mounted to the wheel and axially moveable with respect to the wheel. During a braking action the second brake shoe is adapted to move axially towards the rotor disc and further press the rotor disc against the first brake shoe, resulting in respective frictional engagement between the rotor disc and the first brake shoe, and between the rotor disc and the second brake shoe.

In accordance with one aspect of the invention, the disc brake housing of the assembly comprises an annular radial wall for supporting the first annular brake shoe thereto, and a plurality of link members extending axially from an external periphery of the annular radial wall for detachably connecting an annular radial support structure mounted to the vehicle and housing the rotor disc and the brake shoes. There is a means provided for securing a distal end of the respective link members to the annular radial support structure in a selective axially position so that an axial space between the annular radial wall of the annular radial support structure is selectively determined.

The securing means preferably comprises an elongated aperture defined in the distal end of each link member and extending radially therethrough. A plurality of elongated mounting keys each having a mounting bore extending therethrough for receiving a mounting screw. The mounting bore is offset from a center of the key and the elongated mounting keys are adapted for insertion into the respective elongated apertures in either one of opposite orientations so that the mounting bores are adapted to be selectively located in two different axial positions with respect to the housing.

The disc brake housing is originally assembled with the mounting bores more distal from the annular radial wall of the housing. After the rotor disc and the brake shoes or the brake pads attached thereto become thinner as a result of wear, leaving a longer axial distance for moving parts to travel, the elongated mounting keys, therefore, are reinserted into the respective elongated apertures in the opposite orientation to have the mounting bores located less far away from the annular radial wall so that the axial space between the annular radial wall and the annular radial support structure is smaller. The smaller axial space between the annular radial wall and the radial support structure makes the travel distance of the moving parts shorter and therefore the adjustment is achieved.

In accordance with another aspect of the present invention, a disc brake assembly for a vehicle wheel includes a housing; at least first and second annular brake shoes; at least a rotor disc having first and second annular radial planar friction surfaces substantially parallel to each other, the rotor disc being co-axially mounted to the wheel and axially moveable with respect to the wheel; means for restraining the first brake shoe from rotating with the rotor disc; means for restraining the second brake shoe from rotating with the rotor disc; and an annular fluid expandable bladder, whereby upon expansion of the bladder the second brake shoe moves axially towards the rotor disc and further presses the rotor disc against the first brake shoe, resulting in respective frictional engagement between the first friction surface of the rotor disc and the first brake shoe, and between the second friction surface of the rotor disc and the second brake shoe. The housing comprises an annular radial wall operatively supporting the first annular brake shoe adjacent to the first friction surface of the rotor disc; an annular radial support wall adapted to be mounted to a frame of the vehicle and operatively supporting the bladder and the second annular brake shoe adjacent to the second friction surface of the rotor disc; and means for connecting the annular radial wall to the annular radial support wall in an axially and selectively spaced relationship.

The connecting means preferably comprises a plurality of link members extending axially from an external periphery of the annular radial wall. The link members are preferably equally and circumferentially spaced apart from one another. Each link member preferably includes a distal end having a mounting bore radially extending therethrough for receiving a mounting screw. An axial position of the mounting bore is selectively determined when the link members are connected to the annular radial support wall.

More especially according to one embodiment of the present invention, a disc brake assembly for a vehicle wheel comprises a first annular brake shoe; a first rotor disc co-axially mounted to the wheel, axially spaced apart from the first brake shoe and axially moveable with respect to the wheel; a second annular brake shoe axially spaced apart from the first rotor disc; a second rotor disc co-axially mounted to the wheel, axially spaced apart from the second brake shoe and axially moveable with respect to the wheel; and a third annular brake shoe axially spaced apart form the second rotor. An annular expandable bladder is provided and adapted to move the third brake shoe, second rotor, second brake shoe and second rotor axially towards the first brake shoe upon expansion of the bladder during a brake action, resulting in frictional engagement between the first brake shoe and the first rotor, the first rotor and the second brake shoe, the second brake shoe and the second rotor and the second rotor and the third brake shoe respectively. A housing is provided to house the brake shoes and rotor discs. The housing has an annular radial wall for operatively supporting the first brake shoe and an annular radial support wall adapted to be mounted to a frame of the vehicle for operatively supporting the third brake shoe. Also included in the housing is a means for connecting the annular radial wall to the annular radial support wall in an axially and selectively spaced relationship to adjust an axial space between the annular radial wall and the annular radial support wall so that the travel distance of the axially moveable brake shoes and rotor discs of the disc assembly is adapted to be reduced in order to compensate for wear of friction surfaces of the brake shoes.

The connecting means preferably comprises a plurality of link members extending axially from an external periphery of the annular radial wall and equally and circumferentially space apart from one another. Each link member has an elongated aperture defined at a distal end thereof and extending radially therethrough. A plurality of elongated mounting keys each having a mounting bore extending through the key for receiving a mounting screw are adapted for insertion into the respective elongated apertures. The mounting bore is offset from a center of the key so that the mounting bores are adapted to be selectively located in two different axial positions with respect to the housing when each key is inserted in the bore in opposite orientations.

The disc brake assembly further, preferably comprises means for inhibiting relative rotation between the third brake shoe and the annular radial support wall, and between the third and second brake shoes while permitting relative and axial movement therebetween respectively. A means is also preferably provided for inhibiting the first brake shoe from rotation with respect to the housing.

The present invention advantageously provides a very simple structure of the housing to enable the housing to have selective axial spaces for adjusting the travel distance of the axially moving parts of the disc brake assembly to compensate for wear. The adjustment structure is very reliable because there are no moving parts needed for the adjustment. The adjusted length is dependent on the distance between the center of the bore and the center of the elongated key which can be predetermined within a wide range with no restrictions. This is particularly good for a multiple disc brake assembly which has more than one rotor disc because the more friction surfaces the disc brake assembly has, the longer distance might be necessarily adjusted. As a result of the simple structure, the cost to incorporate the adjustable feature for wear compensation is inexpensive. Other features and advantages of the present invention will be better understood with reference to the preferred embodiment described below.

### BRIEF DESCRIPTION OF THE DRAWINGS

Having thus generally described the nature of the invention, the invention will now be described in detail with reference to the accompanying drawings in which:

FIG. 1 is a partial, longitudinally cross-sectional view of a disc brake assembly incorporating a preferred embodiment of the invention;

FIG. 2 is a perspective view of a disc brake housing in accordance with the preferred embodiment in FIG. 1;

FIG. 3 is a partial front view of FIG. 1, showing the supportive relationship between the first brake shoe and an annular radial wall of the housing;

FIG. 4 is a partial rear view of FIG. 1, showing the connection of link members of the housing to an annular radial support wall and the supportive relationship between the annular radial support wall and the second and third brake shoes;

FIG. 5 is a partial view taken from a direction indicated by arrow P in FIG. 3, showing an original axial location of the mounting bores;

FIG. 6 is the same view illustrated in FIG. 5, showing the adjusted axial location of the mounting bores to compensate for wear;

FIG. 7 is a partial cross-sectional view of a key inserted into the aperture of the link member according to another embodiment of the invention;

FIG. 8 is a partial, longitudinally cross-sectional view of a disc brake assembly incorporating another preferred embodiment of the invention;

FIG. 9 is a partial top view of FIG. 8, showing the engagement of a fork member of the second brake shoe with an axial member of the third brake shoe;

FIG. 10 is a partial cross-sectional view taken along lines B-B in FIG. 9, appearing on the sheet of FIG. 8;

FIG. 11 is a partial, longitudinally cross-sectional view of a disc brake assembly incorporating a further preferred embodiment of the invention; and

FIG. 12 is a partial top view of FIG. 11, appearing on the sheet of FIG. 9 and showing the engagement between the axial members of the second and third brake shoes.

### DESCRIPTION OF THE PREFERRED EMBODIMENT

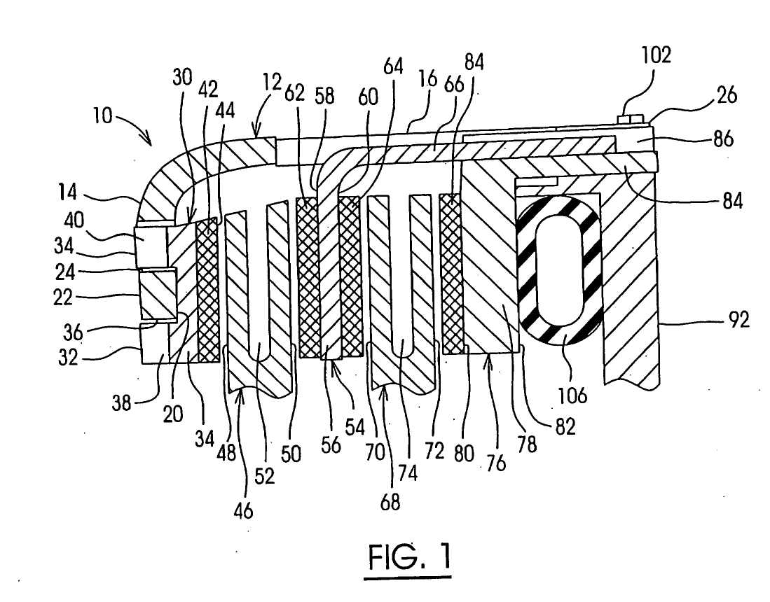

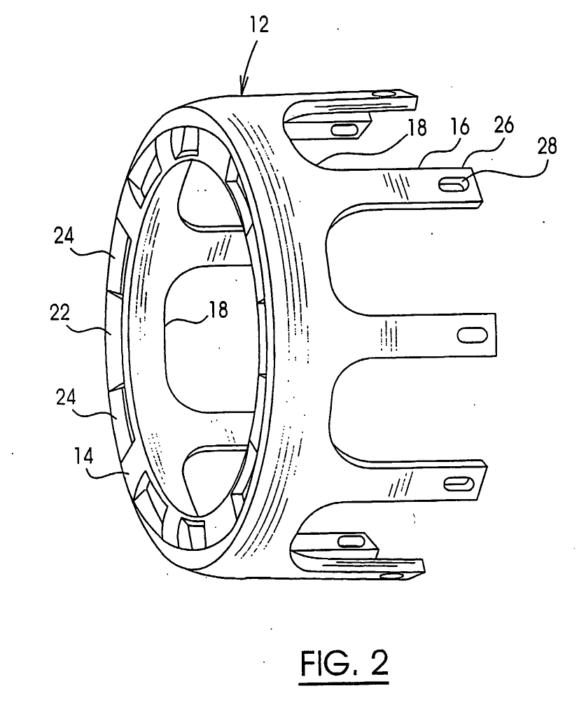

Referring now to drawings, more particularly FIGS. 1 and 2, the disc brake assembly 10 for an automobile wheel (not shown) is illustrated having a housing 12. The housing 12 has an annular radial wall 14 and a plurality of link members 16 extending axially from an external periphery of the annular radial wall 14. The link members 16 are equally and circumferentially spaced apart from one another. Supportive portions 18 are provided between adjacent link members 16, connecting the external periphery of the annular radial wall 14 to increase the strength and solidity of the connection between the link members 16 and the annular radial wall 14. The housing 12 including the annular radial wall 14, the link members 16 and the supportive portions 18 is integrally made from casting metal.

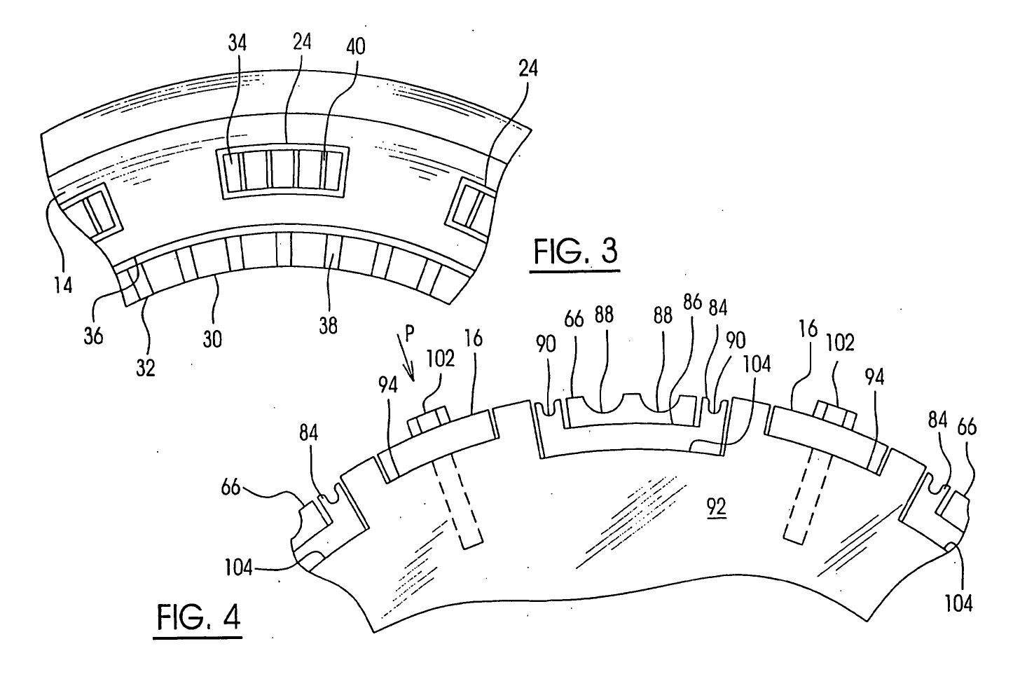

The annular radial wall 14 has a substantially flat inner surface 20 and a smoothly curved outer surface 22. A plurality of openings 24 axially extending through the annular radial wall 14 and equally, circumferentially spaced apart from one another. Each link member 16 includes a distal end 26 having an elongated aperture 28 (shown in FIG. 2) radially extending therethrough. The elongated apertures 28 are axially oriented, each having an axially extending longitudinal axis. A first annular brake shoe 30 includes an annular axial section 32 and an annular radial section 0.34 extending outwardly from the axial section 32. A plurality of axially protruding members 34 that are equally and circumferentially spaced apart from one another and received in the respective openings 24 (see FIG. 3) when the first annular brake shoe 30 is supported to the annular radial wall 14 with the axial section 32 resting on an inner edge 36 of the annular radial wall 14. As shown in FIG. 3, a plurality of radially extending grooves 38 and 40 are provided on the outer surfaces of the respective axial section 32 and the axially protruding members 34 to increase the air contacting surfaces of the first brake shoe 30 for a better cooling solution. The radial section 34 of the first annular brake shoe 30 has an annular inner planar surface 42 on which an annular brake pad 44 is securely attached by any well known mechanism.

Adjacent to the first brake shoe 30 is a rotor disc 46 which is co-axially mounted to the wheel of the vehicle and axially moveable with respect to the wheel, which is well known. The rotor disc 46 includes first and second annular planar friction surfaces 48 and 50 that are parallel to each other and perpendicular to the rotation axis of the wheel. The brake pad 44 is also perpendicular to the rotation axis of the wheel so that the first annular radial planar friction surface 48 is parallel to the first annular brake pad 44 while slightly and axially spaced apart therefrom. A circumferentially extending groove 52 is provided around the rotor disc 46 to improve the cooling condition of the rotor disc.

A second or intermediate annular brake shoe 54 includes a radial section 56 having first and second annular radial planar surfaces 58 and 60, parallel to each other. A pair of annular brake pads 62 and 64 are securely attached to the surfaces 58 and 60 respectively, by any well-known means. The second or intermediate annular brake shoe 54 is positioned adjacent to the first rotor disc 46 at the side opposite to the first brake shoe 30 so that the annular brake pad 62 is parallel to and slightly spaced apart from the annular radial planar friction surface 50 of the first rotor disc. A plurality of axial legs 66 extend axially from the external periphery of the radial section 56 and are equally and circumferentially spaced apart from one another as shown in FIGS. 1 and 4.

Adjacent to the second or intermediate annular brake shoe 54 and at the side opposite to the first rotor disc 46 is a second rotor disc 68. Similarly to the first rotor disc 46, the second rotor disc 68, is co-axially mounted to the wheel of the vehicle and axially moveable with respect to the wheel. Parallel annular radial planar friction surfaces 70 and 72 are perpendicular to the rotation axis of the wheel and a circumferentially extending groove 74 is provided around the rotor disc to improve the cooling condition of the second rotor disc 68. The annular radial planar friction surface 70 is parallel to the brake pad 64 and slightly spaced apart therefrom.

A third annular brake shoe 76 is placed adjacent to the second rotor disc 68, at the side opposite to the second or intermediate annular brake shoe 54. The third annular brake shoe 76 includes a radial section 78 having at opposite sides, two parallel annular radial planar surfaces 80 and 82. An annular brake pad 84 is securely attached to the surface 80 by any well-known means so that the brake pad 84 is parallel to the annular radial planar friction surface 72 of the second rotor disc 68 and slightly spaced apart therefrom. A plurality of axial members 84 radially protrude, axially extend from an external periphery of the radial section 78 and are equally and circumferentially spaced apart, as shown in FIGS. 1 and 4. A recess 86 is provided on an external surface of each axial member 84 and axially extends through the entire axial member. The number of the axial members 84 and the size of the recesses 86 correspond to those of the axial legs 66 of the second or intermediate annular brake shoe 54 so that the axial legs 66 are slidably engaged in the respective recesses of the third annular brake shoe 76. Therefore, the second brake shoe 54 is radially supported to the third brake shoe 76 and a relative axial movement therebetween is permitted but relative rotation is restrained. A plurality of axial grooves 88 and 90 are provided on the external surface of each axial leg 66 and each axial member 84 (see FIG. 4) to increase air contacting surfaces of the second and third annular brake shoe, resulting in a better cooling solution.

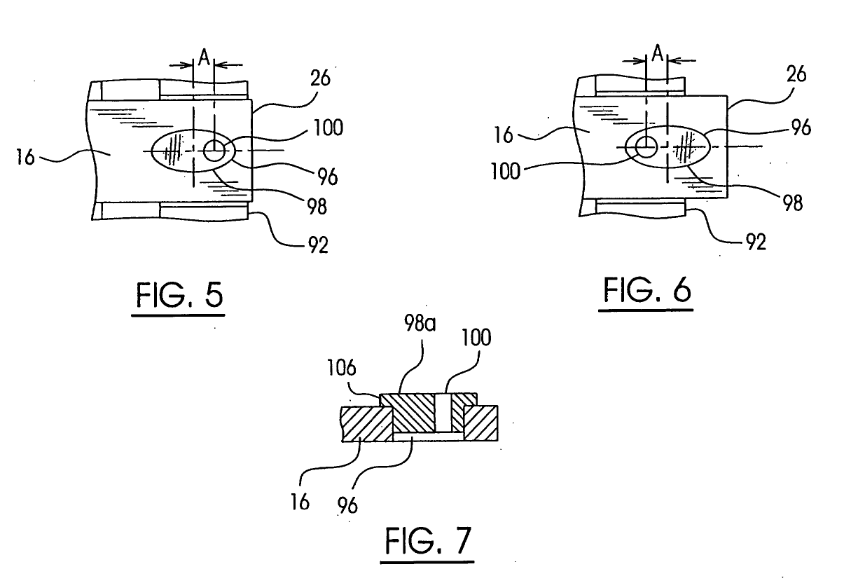

An annular radial support wall 92 is provided in order to hold the disc brake assembly 10 together. The annular radial support wall 92 is adapted to be mounted on a frame of the vehicle and have a first group of grooves 94 extending axially on the external periphery thereof and equally circumferentially spaced apart from one another, as shown in FIG. 4, to receive the respective axial legs 16 of the housing 12. Each axial leg 16 of the housing 12 has an elongated aperture 96 having its longitudinal axis extending axially, as shown in FIG. 5. An elongated key 98, sized and shaped correspondingly to the elongated aperture 96 is inserted into the aperture 98. A mounting bore 100 is defined in the elongated key 98, radially extending through the key for receiving a mounting screw 102 (shown in FIGS. 1 and 4) that is threadably secured to the annular radial support wall 92. The position of the center of the mounting bore 100 is on the longitudinal central line of the key 98, and offset a distance marked A in FIG. 5 from the center of the elongated key 98. The key 98 is oriented so that the mounting bore 100 is offset from the center of the key 98 towards the distal edge of the axial leg 16.

The annular radial support wall 92 includes a second group of grooves 104 extending axially on the external periphery of the annular radial support wall 92 and equally circumferentially spaced apart to slidably receive the respective axial members 84 of the third annular brake shoe 76 with the respective axial legs 66 of the second or intermediate annular brake shoe 54 slidably engaged thereto (see FIG. 4). Therefore, the second and third brake shoes 54 and 76 are radially supported to the annular radial support wall 92. An annular expandable bladder 106 is placed between the annular radial support wall 92 and the radial section 78 of the third annular brake shoe 76. Upon expansion of the bladder 106 when pressurized fluid is forced into it during a brake action, the bladder 106 moves the third annular brake shoe towards the second rotor disc 68. The second rotor disc 68 begins to move towards the second or intermediate annular brake shoe 54 when the second rotor disc is pressed by the third annular brake shoe 76. In a similar procedure the second or intermediate annular brake shoe 54 and the first rotor disc 46 are pressed to move towards the first annular brake shoe 30 until a complete frictional engagement occurs between the brake pad 44 and the annular radial planar friction surface 48, the annular radial planar friction surface 50 and the brake pad 62, the brake pad 64 and the annular radial planar friction surface 70, the annular radial planar friction surface 72 and the brake pad 84 while the first brake shoe is firmly pressed against the inner surface 20 of the annular radial wall 14 of the housing 12. The first brake shoe 30 is inhibited from rotation by the annular radial wall 14 through the axially protruding members 34, and the second and third brake shoes are restrained from rotation by the annular radial support wall 92 through the respective axial legs 16 and axial members 84 so that the functional engagement between the brake shoes and rotor discs will eventually stop the rotation of the rotor discs and bring the vehicle to a full stop. However, before the complete frictional engagement is achieved, relative frictional movement exists between each brake pad and the corresponding friction surface of the rotor discs which produces heat energy and causes wearing of the break pads. Therefore, each brake pad will become thinner and leave more axial distance for the moving parts of the brake to travel after a certain extent of the brake wearing is done. That means, more time is needed to bring the vehicle to a full stop when the driver applies the brakes.

The disc brake assembly 10 according to this embodiment is adapted to adjust the travel distance of the moving parts of the brake. After the travel distance reaches a predetermined extent, the mounting screws 102 are removed. Therefore, the elongated keys 98 can be removed from the elongated apertures 96 and reinserted into the apertures 96 with an opposite orientation so that the mounting bores 100 are located on the other end of the elongated apertures 96, located a longer distance away from the distal edge of the axial leg 16 as shown in FIG. 6. As indicated in FIGS. 5 and 6, the distance between the center of the mounting bore 100 and the center of the key 98 is A, and therefore, the axial position of the mounting bore 100 is moved a distance 2A inwardly from its original position. As a result, the annular radial support wall 92 must be moved a distance 2A inwardly in order to align the mounting bores 100 with the corresponding mounting bores (not shown) in the annular radial support walls 92 to reattach the mounting screws 102 so that the axial distance between the annular radial wall 14 and the annular radial support wall 92 is reduced by 2A. The distance A is predetermined when the disc brake assembly 10 is designed and manufactured.

FIG. 7 illustrates an alternative embodiment of the key 98 that is indicated as 98a and includes a top portion greater than the elongated aperture 96 to form a shoulder 106 around the key 98a. When the key 98a is inserted into the aperture 96, the top portion of the key 98a is left above the aperture 96 that is easily gripped for removal.

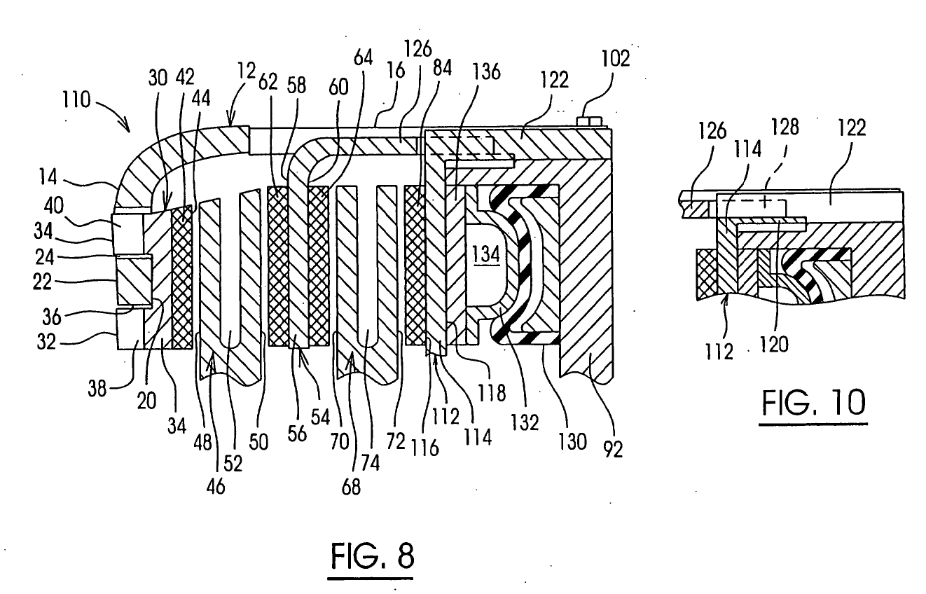

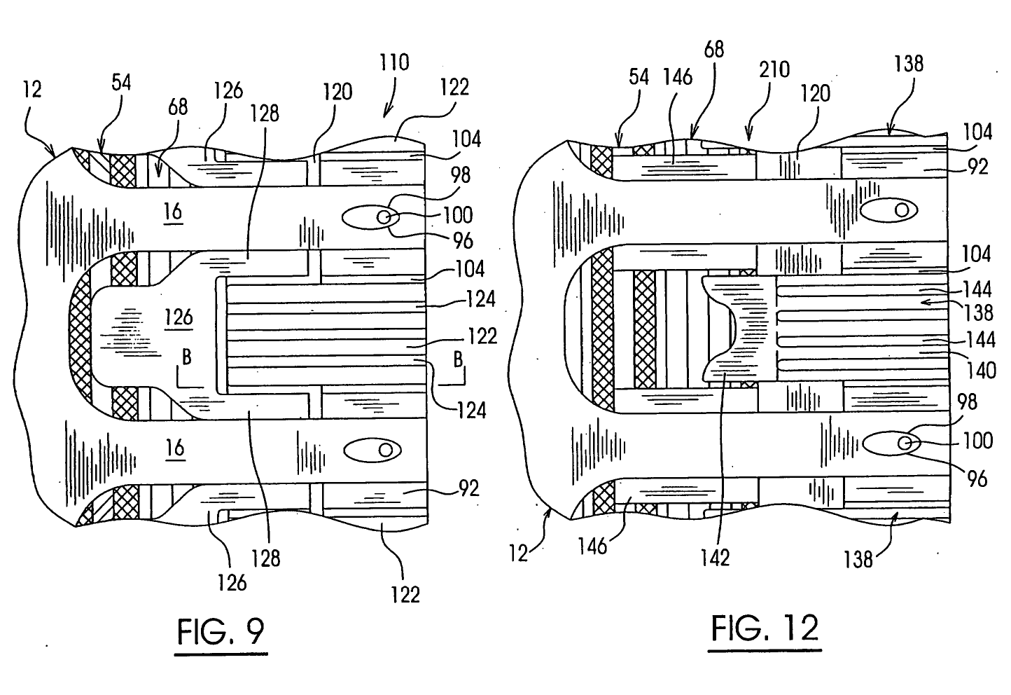

FIGS. 8, 9 and 10 illustrate a disc brake assembly 110 according to another preferred embodiment. The disc brake assembly has structures similar to the disc brake assembly 10 shown in FIG. 1. The similar parts identified by the same numerals indicated in FIG. 1 are not redundantly described. In contrast to the embodiment shown in FIG. 1, the disc brake assembly 110 has a different structural arrangement for inhibiting the rotation of second and third brake shoes and an improved bladder system. A third annular brake shoe 112 includes an annular radial section 114 having at opposite sides, two parallel annular radial planar surfaces 116 and 118. The annular brake pad 84 is securely attached to the surface 116 so that the brake pad 84 is parallel to the annular radial planar friction surface 72 of the second rotor disc 68 and slightly spaced apart therefrom. The third brake shoe 112 further includes an annular axial section 120 to form an external periphery of the third brake shoe 112, which is more clearly shown in FIG. 10. A plurality of axial members 122 protrude radially and axially from the annular axial section 120, being equally and circumferentially spaced apart, as shown in FIGS. 9 and 10. The axial members 122 at their rearward end slidably fit into the respective axial grooves 104 which are located on the periphery of the annular radial support wall 92, more clearly shown in FIG. 4, whereby the third brake shoe 112 is restrained from rotation relative to the housing 12 while permitted axial movement thereto. With such a structure, the third brake shoe 112 is radially supported on the annular radial support wall 92. A plurality of axial grooves 124 are provided on the external surface of each axial member 122 for a better cooling solution.

Instead of the axial legs 66 shown in FIG. 1, a plurality of fork members 126 protrude radially, extend axially from the external periphery of the second brake shoe 54 and are circumferentially spaced apart from one another. Each of the fork members 126 includes two axial legs 128 slidably engaging a front end of a corresponding one of the axial members 122, whereby the second brake shoe 54 is restrained from rotation relative to the third brake shoe 112 but permitted axial movement with respect to both the housing 12 and the third brake shoe 112. Each fork member 126 has a width fitting in the space between two adjacent link members 16 of the housing 12 and the axial legs 128 of the fork member 126 are supported on the annular axial section 122 of the third brake shoe 12.

The disc brake assembly 1110 incorporates an improved bladder system which is described in the applicant's co-pending patent application entitled FLEXIBLE BRAKE SHOE which is incorporated herewith by reference. An annular expandable bladder 130 is adapted to axially compress an annular piston member 139 which has a hollow structure defining an inner annular space 134 therein, and protruding axially from the radial section 114 of the third brake shoe 112. An annular thermal insulator 136 is disposed between the radial section 114 of the third brake shoe 112 and the annular piston member 132. A plurality of bores (not shown) are preferably provided, extending through the annular piston member 132 to communicate with the inner annular space 134 and the outside of the annular piston member 132. With such a structure, the heat produced as a result of the frictional movement between the second rotor disc 68 and the third brake shoe 112 during brake actions, are inhibited from transferring to the annular expandable bladder 130, which improves the working condition of the bladder 130 and thereby prevents premature aging of the material of which the bladder 130 is made.

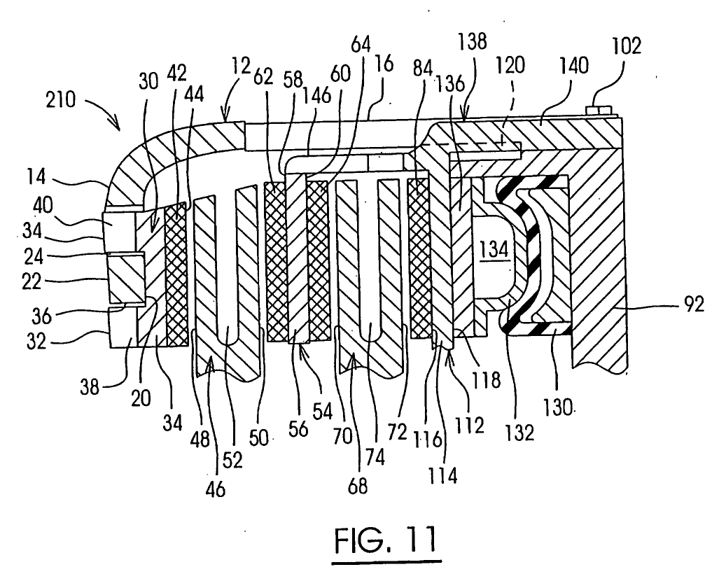

FIGS. 11 and 12 illustrate a further preferred embodiment of the invention, as indicated at numeral 210. The disc brake assembly 210 is similar to the embodiment 10 shown in FIG. 1 and the identical parts indicated by the same numerals are not redundantly described. The improved bladder system of the disc brake assembly 210 is identical to that of the disc brake assembly 110 shown in FIG. 8 which is indicated by the same numerals and not redundantly described. The third brake shoe 112 has a plurality of axial members 138 circumferentially spaced apart from one another. Each axial member 138 includes a first section 140 protruding radially and extending axially and rearwards from the annular axial section 120 of the third brake shoe 112, and a second section 142 extending axially and forwardly from the external periphery of the third brake shoe 112. A plurality of axial grooves 144 are provided on the external surface of the first section 140 of the axial member 138 to increase air contact areas for a better cooling solution. The second section 142 of the axial member 138 has a recessed end as shown in FIG. 12 to reduce the weight thereof. The second brake shoe 54 has a plurality of axial members 146 extending rearwards and axially from the external periphery thereof, and circumferentially spaced apart from one another to slidably engage the second sections 142 of the axial members 138 of the third brake shoe 112, whereby the relative rotation between the second and third brake shoes 54 and 112 is inhibited but axial movement therebetween is permitted. The rearward end of the first section 140 of the axial member 138 of the third brake shoe 112 is slidably received in the grooves 104 of the annular radial support wall 92 to inhibit the third brake shoe 112 from rotation but permit axial movement thereof with respect to the housing 12. The axial members 146 of the second brake shoe are disposed in a circumferential position having a diameter smaller than the diameter of the circumferential position of the link members 16 of the housing 12 so that the axial members 146 of the second brake shoe 54 is contained within the cylindrical space defined by the interior surface of the link members 16 of the housing 12, and radially supported on the inner surface of the link members 16.

Changes and modifications to the embodiment of the invention described above may be made without departing from the spirit and the scope of the invention which are intended to be limited only by the scope of the appended claims.

1. A disc brake housing for a disc brake assembly for a vehicle wheel wherein the disc brake assembly includes at least first and second annular brake shoes, and at least a rotor disc co-axially mounted to the wheel and axially movable with respect to the wheel, during a braking action the second brake shoe being adapted to move axially towards the rotor disc and further press the rotor disc against the first brake shoe, resulting in respective frictional engagement between the rotor disc and the first brake shoe, and between the rotor disc and the second brake shoe, the disc brake housing comprising:
an annular radial wall for supporting the first annular brake shoe thereto;
a plurality of link members extending axially from an external periphery of the annular radial wall for detachably connecting an annular radial support structure mounted to the vehicle, and housing the rotor disc and the brake shoes; and
means for securing a distal end of the respective link members to the annular radial support structure in a selective axial position so that an axial space between the annular radial wall and the annual radial support structure is selectively determined.

2. A disc brake housing as claimed in claim 1 wherein the securing means comprises an elongated aperture defined in the distal end of each link member and extending radially therethrough, and a plurality of elongated mounting keys each having a mounting bore extending therethrough for receiving a mounting screw, the mounting bore being offset from an center of the key and the elongated mounting keys being adapted for insertion into the respective elongated apertures in either one of the opposite orientations so that the mounting bores are adapted to be selectively located in two different axial positions with respect to the housing.

3. A disc brake housing as claimed in claim 2 wherein the elongated aperture has an axially extending longitudinal axis.

4. A disc brake housing as claimed in claim 1 wherein the link members are equally and circumferentially spaced apart from one another.

5. A disc brake housing as claimed in claim 1 wherein the annular radial wall comprises a plurality of openings circumferentially spaced apart from one another, axially extending through the wall for receiving a plurality of axially protruding members of the first brake shoe to prevent the first brake shoe from rotation.

6. A disc brake assembly for a vehicle wheel which includes a housing; at least first and second annular brake shoes; at least a rotor disc having first and second annular radial planar friction surfaces substantially parallel to each other, the rotor disc being co-axially mounted to the wheel and axially movable with respect to the wheel; means for restraining the first brake shoe from rotating with the rotor disc; means for restraining the second brake shoe from rotating with the rotor disc; and an annular expandable bladder, whereby upon expansion of the bladder the second brake shoe moves axially towards the rotor disc and further presses the rotor disc against the first brake shoe, resulting in respective frictional engagement between the first friction surface of the rotor disc and the first brake shoe, and between the second friction surface of the rotor disc and the second brake shoe; the housing comprising:
an annular radial wall operatively supporting the first annular brake shoe adjacent to the first friction surface of the rotor disc;
an annular radial support wall adapted to be mounted to a frame of the vehicle and operatively supporting the bladder and the second annular brake shoe adjacent to the second friction surface of the rotor disc; and
means for connecting the annular radial wall to the annular radial support wall in an axially and selectively spaced relationship.

7. A disc brake assembly as claimed in claim 6 wherein the connecting means comprises a plurality of link members extending axially from an external periphery of the annular radial wall.

8. A disc brake assembly as claimed in claim 7 wherein each link member includes a distal end having a mounting bore radially extending therethrough for receiving a mounting screw, an axial position of the mounting bore being selectively determined when the link members are connected to the annular radial support wall.

9. A disc brake assembly as claimed in claim 7 wherein the link members are equally and circumferentially spaced apart from one another.

10. A disc brake assembly as claimed in claim 7 wherein each link member comprises an elongated aperture defined at a distal end thereof and extending radially therethrough, and a plurality of elongated mounting keys each having a mounting bore extending through the key for receiving a mounting screw, the mounting bore being offset from an center of the key and the elongated mounting keys being adapted for insertion into the respective elongated apertures in opposite orientations so that the mounting bores are adapted to be selectively located in two different axial positions with respect to the housing.

11. A disk brake assembly as claimed in claim 10 wherein the elongated aperture of each link member has an axially extending longitudinal axis.

12. A disk brake assembly as claimed in claim 11 wherein each key has a longitudinal central line extending, through a center of the mounting bore defined in the key.

13. A disc brake assembly as claimed in claim 6 wherein the annular radial wall comprises a plurality of openings circumferentially spaced apart from one another, and axially extending through the wall for receiving a plurality of axially protruding members of the first brake shoe to prevent the first brake shoe from rotation.

14. A disc brake assembly for a vehicle wheel comprising:
a first annular brake shoe;
a first rotor disc co-axially mounted to the wheel, axially spaced apart from the first brake shoe and axially moveable with respect to the wheel;
a second annular brake shoe axially spaced apart from the first rotor disc;
a second rotor disc co-axially mounted to the wheel, axially spaced apart from the second brake shoe and axially moveable with respect to the wheel;
a third annular brake shoe axially spaced apart from the second rotor;
an annular expandable bladder adapted to move the third brake shoe, second rotor, second brake shoe and second rotor axially towards the first brake shoe upon expansion of the bladder during a brake action, resulting in frictional engagement between the first brake shoe and the first rotor, the first rotor and the second brake shoe, the second brake shoe and the second rotor, and the second rotor and the third brake shoe respectively; and
a housing having an annular radial wall for operatively supporting the first brake shoe, an annular radial support wall adapted to be mounted to a frame of the vehicle for operatively supporting the third brake shoe, and means for connecting the annular radial wall to the annular radial support wall in an axially and selectively spaced relationship to adjust an axial space between the annular radial wall and the annular radial support wall so that a travel distance of the axially moveable brake shoes and rotor discs of the disc brake assembly is adapted to be reduced in order to compensate for wear of friction surfaces of the brake shoes.

15. A disc brake assembly as claimed in claim 14 wherein the connecting means comprises a plurality of link members extending axially from an external periphery of the annular radial wall and equally and circumferentially spaced apart from one another, a distal end of the respective link members being detachably secured to the annular radial support wall in a selected axial location.

16. A disc brake assembly as claimed in claim 15 wherein each link member comprises an elongated aperture defined at the distal end thereof and extending radially therethrough, and a plurality of elongated mounting keys each having a mounting bore extending through the key for receiving a mounting screw, the mounting bore being offset from an center of the key and the elongated mounting keys being adapted for insertion into the respective elongated apertures in opposite orientations so that the mounting bores are adapted to be selectively located in two different axial positions with respect to the housing.

17. A disc brake assembly as claimed in claim 14 further comprising means for inhibiting relative rotation between the third brake shoe and the annular radial support wall, and between the second and third brake shoes while permitting relative and axial movement therebetween respectively, and means for inhibiting the first brake shoe from rotation with respect to the housing.

18. A disc brake assembly as claimed in claim 14 wherein the annular radial wall comprises a plurality of openings circumferentially spaced apart from one another, and axially extending through the wall for receiving a plurality of axially protruding members of the first brake shoe to prevent the first brake shoe from rotation.

19. A disc brake assembly as claimed in claim 15 wherein the third brake shoe comprises a plurality of axial members circumferentially spaced apart from one another, each having a first section protruding radially, extending axially and rearwards from an external periphery thereof, and the annular radial support wall includes a plurality of grooves axially extending on an external periphery thereof and circumferentially spaced apart from one another, flanking the respective link members of the housing, the grooves slidably engaging a rearward end of the first section of the respective axial members so that the third brake shoe is radially supported thereto and inhibited from rotation but permitted for axial movement with respect to the housing.

20. A disc brake assembly as claimed in claim 19 wherein the third brake shoe includes a radial recess axially extending on the first section of each axial member thereof, and the second brake shoe includes a plurality of axial legs slidably engaging the respective recesses of the third brake shoe so that the second brake shoe is radially supported to the third brake shoe, inhibited from rotation relative to the housing but permitted for axial movement with respect to both the housing and the third brake shoe.

21. A disc brake assembly as claimed in claim 19 wherein the second brake shoe include a plurality of fork members protruding radially and extending axially from an external periphery thereof and circumferentially spaced apart from one another, each of the fork members including two axial legs slidably engaging a front end of the first section of the axial members of the third brake shoes so that the second brake shoe is inhibited from rotation relative to the housing but permitted for axial movement with respect to both the housing and the third brake shoe.

22. A disc brake assembly as claimed in claim 21 wherein the fork members of the second brake shoe is radially supported on the external periphery of the third brake shoe.

23. A disc brake assembly as claimed in claim 19 wherein each of the axial members of the third brake shoe includes a second section extending axially and forwardly from the external periphery of the third brake shoe, and the second brake shoe includes a plurality of axial members extending axially and rearwards from an external periphery thereof, the axial members of the second brake shoe slidably engaging the second sections of the axial members of the third brake member respectively to inhibit relative rotation between the second and third brake shoes but permitting axial movement therebetween.

24. A disc brake assembly as claimed in claim 23 wherein the axial members of the second brake shoe are radially supported to an inner surface of the link members of the housing.
